(19) United States
(12) Patent Application Publication
(10) Pub. No.: US 2015/0046443 A1
(43) Pub. Date: Feb. 12, 2015

(54) DOCUMENT-BASED SEARCH WITH FACET INFORMATION

(71) Applicant: International Business Machines Corporation, Armonk, NY (US)

(72) Inventors: Gilad Barkai, Haifa (IL); Shai Erera, Kiryat Ata (IL); Ido Uy, Haifa (IL); Inbal Ronen, Haifa (IL); Eitan Shapiro, Haifa (IL); Sivan Yogev, Givat Haim Meuchad (IL)

(73) Assignee: International Business Machines Corporation, Armonk, NY (US)

(21) Appl. No.: 13/964,080

(22) Filed: Aug. 11, 2013

(51) Int. Cl. G06F 17/30

(52) U.S. Cl. CPC G06F 17/30867
USPC 707/732

(57) ABSTRACT

A method comprising using at least one hardware processor for: executing, based on a query, a document-oriented search in an index of documents each associated with at least one profile, to output a set of document results; executing, based on the set of document results, a profile-oriented search in an index of profiles, to output a set of profile results and facets associated with the profile results; and displaying the set of profile results and the facets.

### BACKGROUND

The invention relates to the field of database searches.

In today's interconnected world, there is an ever-growing need to be able to quickly and easily find people knowledgeable in a given topic. This may be done by executing a computerized search, either via a wide-area network such as the Internet or via an organizational intranet, to locate people having a desired expertise.

There are a number of approaches to expertise search. One prominent approach, often termed the “profile-based” approach, involves the building of profiles for experts, and ranking search results according to the relevancy of the profiles to a given query. Another prominent approach, commonly called the “document-based” approach, ranks experts by searching and quantifying documents associated with these experts. These documents may include any type of media available digitally, such as articles, blog posts, wiki pages, white papers, technical specifications, recorded lectures, videos, comments, etc. The expert may be either the author of such media and/or be otherwise associated with it, such by way of having commented on the media, being mentioned in the media, “liking” or voting for the media, etc.

In the “profile-based” approach, it is common to provide a “faceted search” functionality, in which expert profiles may be filtered and/or sorted according to certain attributes—being the facets. For example, facets of a certain set of returned profile results can show the user how the experts are distributed across countries, companies, industries, business units, spoken languages, social proximity to the user, and/or the like. The user may then choose to drill-down into one or more specific facets, by filtering the results in accordance with facet values (e.g., experts in “machine learning” from Europe who speak Spanish).

The foregoing examples of the related art and limitations related therewith are intended to be illustrative and not exclusive. Other limitations of the related art will become apparent to those of skill in the art upon a reading of the specification and a study of the figures.

### SUMMARY

The following embodiments and aspects thereof are described and illustrated in conjunction with systems, tools and methods which are meant to be exemplary and illustrative, not limiting in scope.

There is provided, in accordance with an embodiment, a method comprising using at least one hardware processor for: executing, based on a query, a document-oriented search in an index of documents each associated with at least one profile, to output a set of document results; executing, based on the set of document results, a profile-oriented search in an index of profiles, to output a set of profile results and facets associated with the profile results; and displaying the set of profile results and the facets.

There is further provided, in accordance with an embodiment, a computer program product for conducting a database search, the computer program product comprising a non-transitory computer-readable storage medium having program code embodied therewith, the program code executable by at least one hardware processor to: execute, based on a query, a document-oriented search in an index of documents each associated with at least one profile, to output a set of document results; execute, based on the set of document results, a profile-oriented search in an index of profiles, to output a set of profile results and facets associated with the profile results; and display the set of profile results and the facets.

There is yet further provided, in accordance with an embodiment, a method comprising using at least one hardware processor for: receiving a query; searching a document index with the query, to return a set of document results, wherein each document in the document index is associated with at least one personal profile; searching a personal profile index for the at least one personal profile, to return a set of personal profile results and facets associated with the personal profile results; and displaying the set of personal profile results and the facets.

In some embodiments, said executing of the profile-oriented search comprises enumerating the facets of the set of profile results and displaying a result of said enumerating.

In some embodiments, the method further comprises using said at least one hardware processor for filtering the set of profile results based on a user request to drill-down into one or more of said facets of the set of profile results.

In some embodiments, the method further comprises using said at least one hardware processor for ranking the set of profile results based on a user request to promote profiles of the set of profile results having a defined facet value.

In some embodiments, said index of profiles is an index of personal profiles.

In some embodiments, said query is descriptive of an expertise.

In some embodiments, the method further comprises using said at least one hardware processor for ranking the set of profile results according to relevancy.

In some embodiments, said execute of the profile-oriented search comprises enumerating the facets of the set of profile results and displaying a result of said enumerating.

In some embodiments, the program code is further executable by said at least one hardware processor to filter the set of profile results based on a user request to drill-down into one or more of said facets of the set of profile results.

In some embodiments, the program code is further executable by said at least one hardware processor to rank the set of document results according to relevancy.

In some embodiments, the program code is further executable by said at least one hardware processor to rank the set of profile results according to relevancy.

In some embodiments, the method further comprises using said at least one hardware processor for ranking said set of personal profile results in accordance with an intensity of association between: the query; each document of the set of document results; and each personal profile of the set of personal profile results.

In some embodiments, said searching of the personal profile index comprises enumerating the facets of the set of personal profile results and displaying a result of said enumerating.

In some embodiments, said searching of the document index and said searching of the personal profile index are performed automatically, based on said receiving of the query.

In addition to the exemplary aspects and embodiments described above, further aspects and embodiments will become apparent by reference to the figures and by study of the following detailed description.

### BRIEF DESCRIPTION OF THE FIGURES

Exemplary embodiments are illustrated in referenced figures. Dimensions of components and features shown in the figures are generally chosen for convenience and clarity of presentation and are not necessarily shown to scale. The figures are listed below.

FIG. 1 shows a schematic of an exemplary a cloud computing node;

FIG. 2 shows an illustrative cloud computing environment;

FIG. 3 shows a set of functional abstraction layers provided by the cloud computing environment;

FIG. 4 shows a flowchart of a method for conducting a search;

FIG. 5 shows an exemplary GUI (graphical user interface) for conducting and displaying results of an expertise search;

FIG. 6 shows the exemplary GUI after the user selected a tag from a tag cloud;

FIG. 7 shows the exemplary GUI after the user selected a facet value;

FIG. 8 shows the exemplary GUI after the user selected another facet value;

FIG. 9 shows the exemplary GUI following a drill-down of two levels; and

FIG. 10 shows an additional GUI for displaying evidence for a set of results.

### DETAILED DESCRIPTION

A computer-based search method is disclosed herein. Advantageously, in response to a query input by a user, the present method carries out at least two searches: First, a document-oriented search is executed. Then, a profile-oriented search is performed based on results of the first search. Finally, the user is presented with results of the second, profile-oriented search, which results contain information as to one or more facets of found profiles. Optionally, the results also include enumeration of the one or more facets, in order to present to the user the distribution of the found profiles across different facets.

The term “document”, as referred to herein, may relate to any type of media available digitally, such as an article, a blog post, a white paper, a technical specifications, a web page, a recorded lecture, a video, a comment, etc.

The term “document index”, as referred to herein, may relate to a computerized index of documents. The index may be based on a crawling of the actual documents and the fetching of some or the entirety of their contents.

The term “document-oriented search” (or “document-based search”), as referred to herein, may relate to a search executed in a document index based on a certain query input by a user.

The term “profile”, as referred to herein, may relate to a document, a list, and/or the like which describes a certain subject, such as a person, a product, or the like. For example, a personal profile is descriptive of a person and a product profile is descriptive of a product. Each such profile may include data divided into multiple facets.

The term “facet”, as referred to herein, may relate to an attribute, a characteristic and/or a quality of the subject. For example, a personal profile may include the following facets: geographic location of the person, place of work of the person, age, gender, academic credentials, spoken language, associated industry, etc., as well as personalized facets such as the social distance to the searcher, etc; a product may include facets such as its price, its manufacture, its number of recommendations, its size, weight, etc. Values of facets may include, for instance, “United States” or “Canada” for the geographic location facet “IBM” for the place of work facet, “1500 USD” for the price facet, etc.

The term “profile index”, as referred to herein, may relate to a computerized index of profiles. The index may be based on a crawling of the actual profiles and the fetching of some or the entirety of their contents.

The term “profile-oriented search” (or “profile-based search”), as referred to herein, may relate to a search executed in a profile index based on a certain query, such as a query resulting from a document-oriented search.

Although the terms “document index” and “profile index” are discussed here separately, it is explicitly intended that these indexes may be realized, in some embodiments, in a single index. For example, such an index may include multiple documents, some being of a regular document type and some of a “profile” type. The index may include associations between the regular documents and the profile-type documents.

The present method may be applied, for example, for expertise searches. In an expertise search, a user may input a query of one or more words descriptive of at least one certain expertise, in an attempt to locate one or more persons having that expertise. Based on this query, a document-oriented search is executed, to locate and rank documents appearing in a document index. Each such document may have one or more persons associated with it, for example as authors, commentators, etc. Once the documents relevant to the query are located, a second search may be executed, this time in an index of profiles, to fetch various facets associated with each person located in the first, document-oriented search. These facets may relate to different characteristics of the personal profile, such as the geographic location of the pertinent person, his or her place of work, etc. The results of the second search may be presented to the user. These results may include the most relevant personal profiles located, as well as optionally information as to facets of these personal profiles. Further optionally, a facet count may be displayed for each facet. The facet counts may be an enumeration of each facet value existing in the personal profiles located. For example, the facet counts may indicate that an X amount of the persons found reside in the United States, whereas a Y amount of persons work at IBM.

As another example, the present method may be applied to product searches. In a product search, according to the present method, the user may input a query indicative of some characteristic of a product—whether physical goods or intangible ones. Then, the method may execute a document-oriented search in a document index, for locating documents relevant to the query. The located documents may serve as a query to a second search, this time a profile-oriented search in an index of product profiles (also “specifications”). The second search may yield a set of product profiles relevant to the query, and optionally a facet count for this set of product profiles.

Those of skill in the art will recognize that the present method may be applied to other types of search, and is not limited to expertise and product searches. However, for simplicity and clarity of discussion, the following description is provided with reference to an expertise search.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a hardware processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

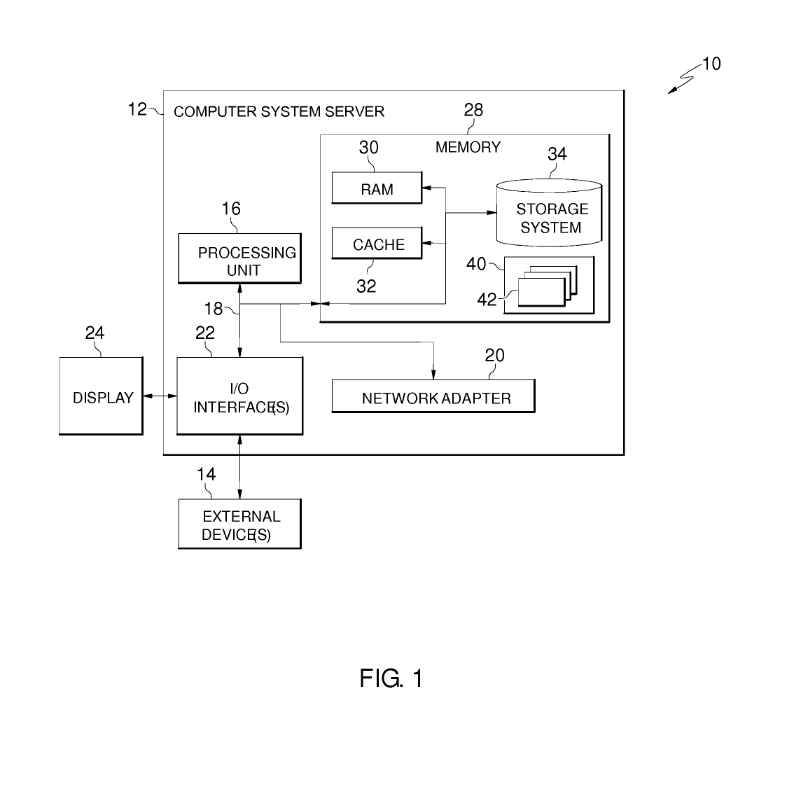

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system.

Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

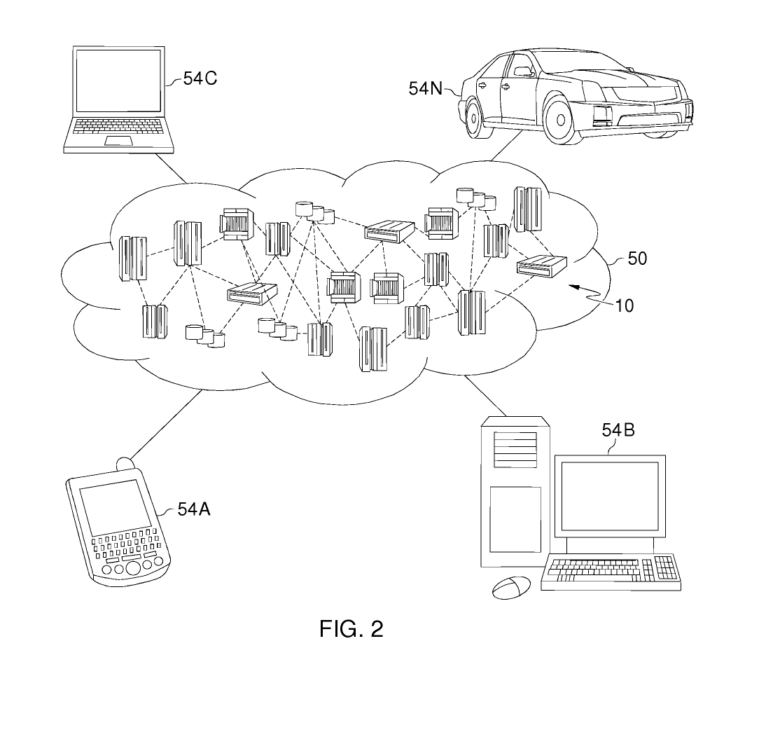

Referring now to FIG. 2, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

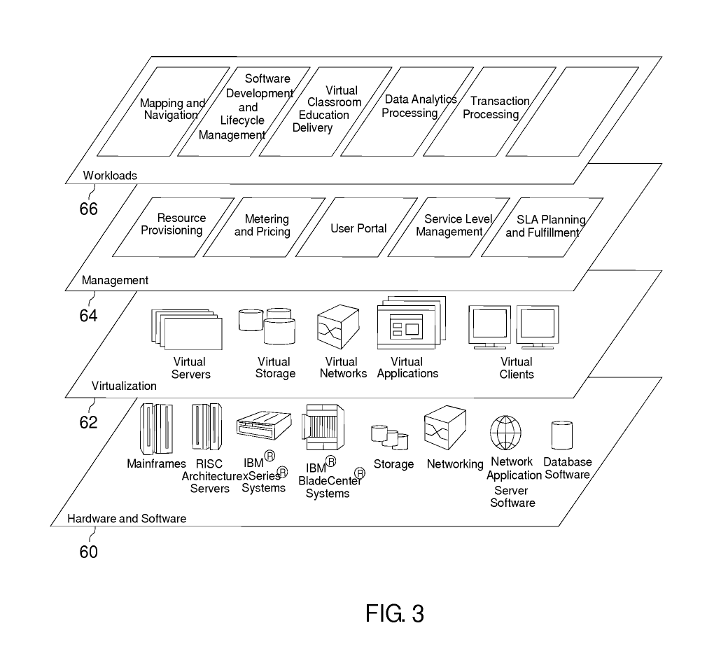

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Hardware and software layer 60 includes hardware and software components. Examples of hardware components include mainframes, in one example IBM® zSeries® systems; RISC (Reduced Instruction Set Computer) architecture based servers, in one example IBM pSeries® systems; IBM xSeries® systems; IBM BladeCenter® systems; storage devices; networks and networking components. Examples of software components include network application server software, in one example IBM WebSphere® application server software; and database software, in one example IBM DB2® database software. (IBM, zSeries, pSeries, xSeries, BladeCenter, WebSphere, and DB2 are trademarks of International Business Machines Corporation registered in many jurisdictions worldwide).

Virtualization layer 62 provides an abstraction layer from which the following examples of virtual entities may be provided: virtual servers; virtual storage; virtual networks, including virtual private networks; virtual applications and operating systems; and virtual clients.

In one example, management layer 64 may provide the functions described below. Resource provisioning provides dynamic procurement of computing resources and other resources that are utilized to perform tasks within the cloud computing environment. Metering and Pricing provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal provides access to the cloud computing environment for consumers and system administrators. Service level management provides cloud computing resource allocation and management such that required service levels are met. Service Level Agreement (SLA) planning and fulfillment provide pre-arrangement for, and procurement of, cloud computing resources for which a future requirement is anticipated in accordance with an SLA.

Workloads layer 66 provides examples of functionality for which the cloud computing environment may be utilized. Examples of workloads and functions which may be provided from this layer include: mapping and navigation; software development and lifecycle management; virtual classroom education delivery; data analytics processing; transaction processing; and

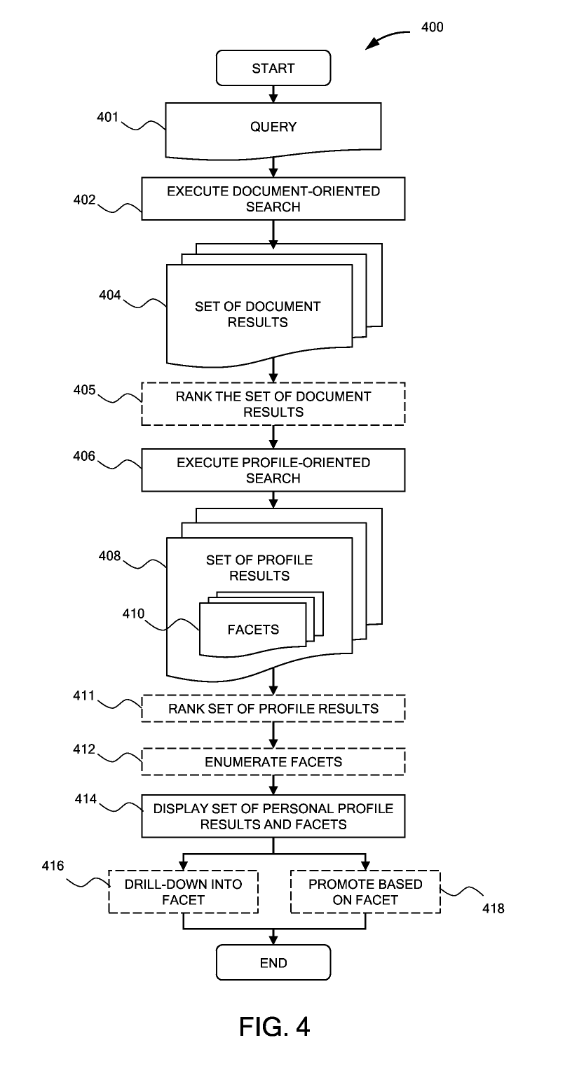

Reference is now made to FIG. 4, which shows a flowchart of a method 400 for conducting a search, such as an expertise search, in accordance with an embodiment.

In a step 402, a document-oriented search is executed based on a query 401. The document-oriented search may be executed in an index of documents. Each of these documents may have one or more personal profiles associated with it. For example, a blog post document may have associated with it an author, a number of commentators, a number of “likers”, and a person mentioned in the contents of the post. A shared file may be associated with an author, a number of sharers who share it with others; a number of others who were shared this file with; a number of commenters; a number of “likers”, a number of downloaders, etc. However, it is intended that any type of association might exist between a document and one or more personal profiles.

The document-oriented search of step 402 may result in a set of document results 404. The set includes a list of documents which have been found to be relevant to the query. Optionally, the execution of the search also includes a ranking 405 of the list of documents, such that the list may be arranged from the most relevant document to the least relevant one. Methods of ranking search results based on their relevancy to a query are known in the art.

In a step 406, a profile-oriented search is executed. The profile-oriented search may be executed in an index of profiles. The profile-oriented search may be executed based on the set of document results 404, which serves here as a search query.

In the profile-oriented search, personal profiles associated with the set of document results 404 are fetched, along with facets associated with each of these personal profiles. The facets may pre-exist in the index or profiles (as a result of an earlier profile indexing step) or, alternatively, be fetched at the time of searching from the personal profiles themselves.

The profile-oriented search of step 406 may result in a set of personal profile results 408 along with facets 410 of each profile of these results. Optionally, the execution of the profile-oriented search also includes a ranking 411 of the set of personal profiles, such that the set may be arranged from the most relevant personal profile to the least relevant one. Methods of ranking search results based on their relevancy to a query are known in the art. For example, the ranking of the set of personal profile results 408 may be in accordance with an intensity of association between query 401, each document of the set of document results 404 and each personal profile of the set of personal profile results 408. This intensity may be computed, at a first stage, in accordance with the ranking of the set of document results 404, which is performed based on an intensity of their association with the query. Then, at a second stage, the intensity computed at the first stage may be compounded with an intensity between the ranked set of document results 404 and each personal profile of the set of personal profile results 404.

In an optional step 412, facets 410 are enumerated. That is, the number each facet value is repeated across the set of personal profile results 404 is counted. For example, the number of appearances of the facet value “USA” across the “Geographic location” facet of the set of personal profile results 404 is counted.

In a step 414, the set of personal profile results 408 and facets 410 may be displayed or otherwise presented to the user, for example visually—using a computerized screen and/or vocally—using a screen reader. If facets 410 were enumerated in optional step 412, the result of the enumeration (or the “count”) may be displayed alongside the display of the facets.

In an optional step 416, the user may elect to drill-down into (or “filter in accordance with”) one or more of facets 410 of the set of profile results 408. The drill-down may include the user selecting one or more facet values, thereby filtering the set of profile results 408 to include only those personal profiles having the selected facet value. As an example, the user may select the facet value “USA”, thereby filtering the set of profile results 408 to display only those personal profiles of persons located in the USA.

In an optional step 418, the user may elect to promote (also “boost”) certain personal profiles of the set of profile results 408, based on them having a certain facet value. This promotion is different from the filtering of step 416, in that it does not remove personal profiles from the set of profile results 408, but rather only re-arranges the set of profile results. By way of example, the user may elect to promote personal profiles having the value “Canada” in their “Geographic location” facet. This will trigger a re-arranging of the set of profile results 408, to promote those personal profiles having the value “Canada” in their “Geographic location” facet, and demote personal profiles having a different value in their “Geographic location” facet.

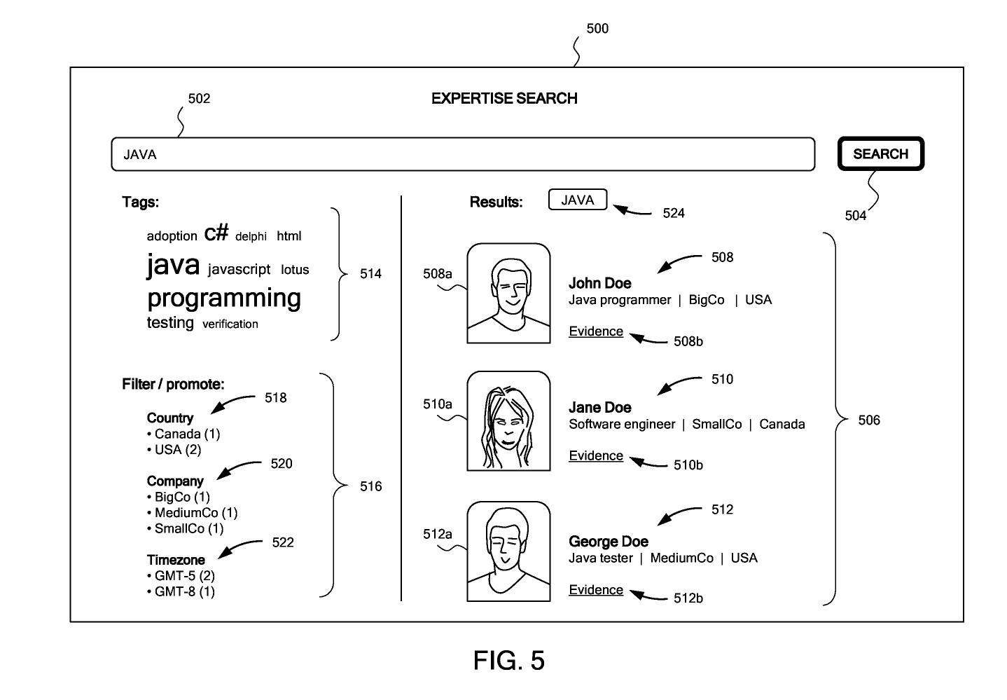

Reference is now made to FIG. 5, which shows an exemplary GUI (graphical user interface) 500 for conducting and displaying results of an expertise search. GUI 500 is shown with an arbitrary layout, for purposes of illustration only. Those of skill in the art will recognize that present embodiments may utilize a GUI in which the design and/or functionality is different.

GUI 500 may include an input field, such as a text field 502, for receiving a query from a user. The user may type the query, in this example the word “Java”, or use a different input means for entering the query (such as voice recognition, etc.). After the query has been entered, the user may issue a command to conduct a search based on the query, for example by pressing a “search” button 504. Alternatively, the user may press a keyboard key, such as “enter”. Further alternatively, search may commence instantly while the user is still typing, and/or following a predefined delay during the typing, such that the user does not have to issue a separate command for initiating the search.

For the purpose of the discussion of GUI 500, it is assumed that an exemplary set of three personal profiles is to be displayed and/or manipulated. These personal profiles are summarized in the table below:

TABLE 1

| | John Doe | Jane Doe | George Doe |
|---|---|---|---|
| Country | USA | Canada | USA |
| Company | BigCo | SmallCo | MediumCo |
| Time zone | GMT-5 | GMT-8 | GMT-5 |
| Skills | adoption, java, | c#, delphi, html, | java, javascript, |
| | javascript, lotus, | java, javascript, | programming, |
| | programming, | programming | testing, verification |
| | testing, verification | | |

The leftmost column in Table 1 shows the various facets existing in the personal profiles on John Doe, Jane Doe and George Doe. The remaining three columns show the values of these facts for the three personal profiles.

After the search is conducted, for example in accordance with method 400 of FIG. 4, a set of personal profile results 506 may be displayed. In this example, three personal profiles have been found: those of John Doe 508, Jane Doe 510 and George Doe 512. However, it is explicitly intended that a set of personal profile results may include any number of personal profiles. In addition, these profiles may extend over more than a single “page”, namely—moving to one or more additional pages in GUI 500 may be necessary for viewing all profiles in the set.

Set 506 may be a list which includes, for example, the name of the person and/or at least on additional detail characterizing the person, such as his or her title, place of work, country, etc. In the present example, the title “Java programmer”, the place of work “BigCo” and the country “USA” are shown for John Doe 508; the title “Software engineer”, the place of work “SmallCo” and the country “Canada” are shown for Jane Doe 510; and the title “Java tester”, the place of work “Medium Co” and the country “USA” are shown for George Doe 512. Optionally, set 506 also includes a photograph, if one is available, for at least some of the personal profiles found; a photograph 508a of John Doe, a photograph 510a of Jane Doe and a photograph 512a of George Doe.

GUI 500 may include a display of breadcrumbs, namely—one or more textual elements serving as navigational aids. In this example, a “java” breadcrumb 524 is shown. This indicates to the user his or her present location in the navigation of GUI 500.

Advantageously, in addition to set 506, facet information is also displayed in GUI 500. The facet information may displayed in any convenient manner; the discussions below illustrate two such exemplary way of displaying facet information: using a tag cloud and using a filtering/promotion section.

The facet information may include, as a first example, a tag cloud (also “word cloud” or “weighted list) 514. Tag cloud 514 may be a visual representation for text data, used to depict the prominence of certain keyword, in this case facet values, in set 506. Tags shown in tag cloud 514 may each be a single word or multiple words, and the importance (or “prominence”) of each tag is shown by font size; bigger fonts indicate higher importance, and vice versa. This format is useful for quickly perceiving the most prominent facet values and for locating a term alphabetically to determine its relative prominence. Optionally, tag cloud 514 doubles as a navigation aid, in which the terms are hyperlinked to items associated with the tag.

The facet information may include, as a further example, a filtering and/or promotion section 516, in which one or more facets are displayed. For instance, section 516 may display a country facet 518, a company (also “place of work”) facet 520 and a time zone facet 522.

Since Jane Doe 510 is from Canada, country facet 518 shows the word Canada, optionally with an enumeration (or “count”) of “1” in parentheses next to it. This indicates that set 506 includes one person from Canada. Set 518 includes two people from the USA—John Doe 508 and George Doe 512, and, hence, the word USA is shown with an enumeration “2” next to it.

Similarly, company facet 520 and time zone facet 522 show the companies and time zones of the persons appearing in set 506, as well as an optional enumeration of values of these facets.

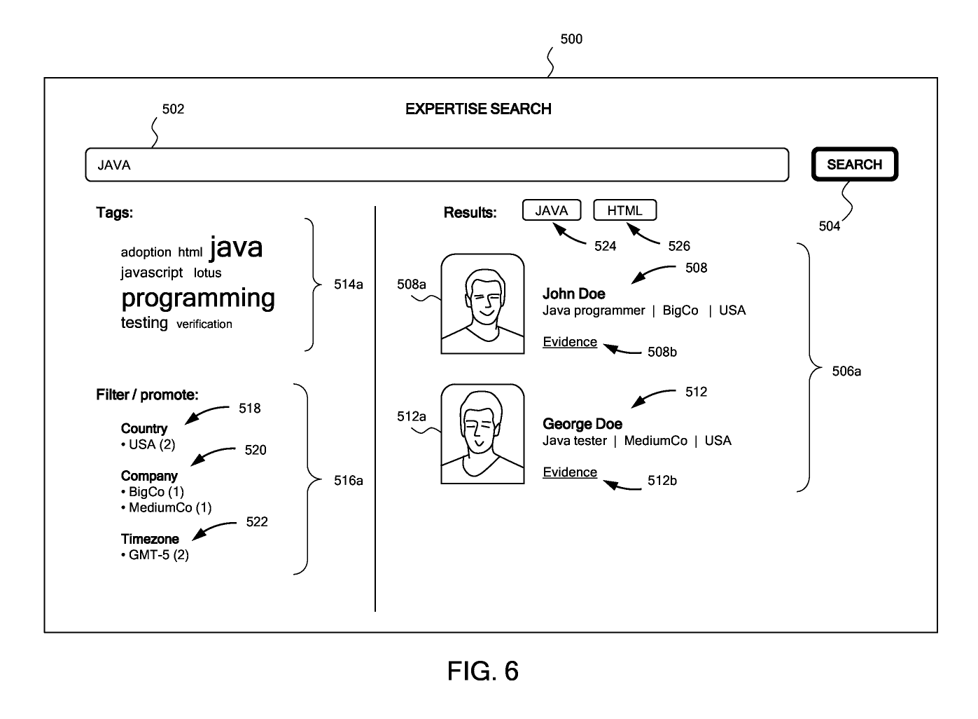

Reference is now made to FIG. 6, which shows GUI 500 after the user selected an “html” tag from tag cloud 514. This illustrates an exemplary behavior of GUI 500 upon selecting any tag from tag cloud 514. Set 506 (FIG. 5) has now been filtered, resulting in a reduced set 506a which only shown those personal profiles having a facet value of “html”, in this example John Doe 508 and George Doe 512. An “html” breadcrumb 526 has been added next to “java” breadcrumb 524.

Further, the filter/promote section 516 has been updated, to indicate only the facets existing for reduced set 506a, namely—two persons from the USA, one person from BigCo, one person from MediumCo and two persons residing in the GMT-5 time zone. Similarly, tag cloud 514 has been updated to remove those tags irrelevant for John Doe 508 and George Doe 512, in this example—the “c#” and “delphi” tags.

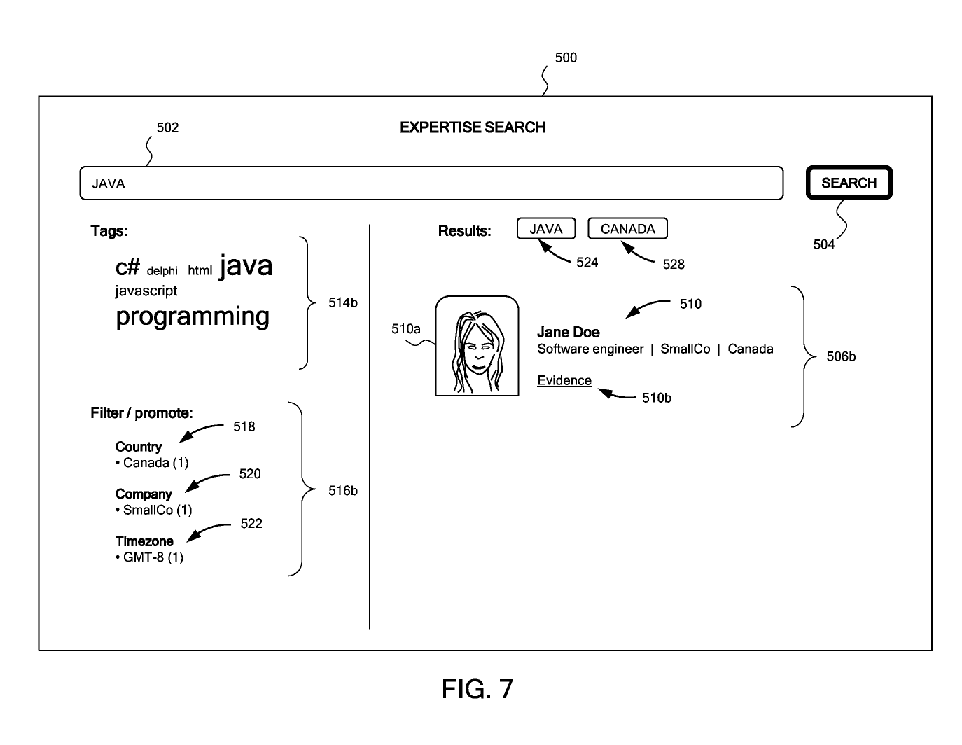

Reference is now made to FIG. 7, which shows GUI 500 after the user selected the company facet 520 value “Canada”, and indicated that a filtering (or a “drill-down”) based on that value is desired. Since Jane Doe 510 is the only person from Canada appearing in set 506 (FIG. 4), this set has been filtered to result in a filtered set 506b including only Jane Doe.

In accordance with the sole appearance of Jane Doe 510 in filtered set 506b, section 516 (FIG. 4) has been filtered, to result in a filtered set 516b displaying only facets existing for reduced set 506b, namely—one person from Canada, one person from SmallCo and one person from time zone GMT-8. Further, a “Canada” breadcrumb 528 has been added next to “java” breadcrumb 524. Further, tag cloud 514 (FIG. 5) has been updated to a filtered tag cloud 514, now including only those facets relevant to Jane Doe 510.

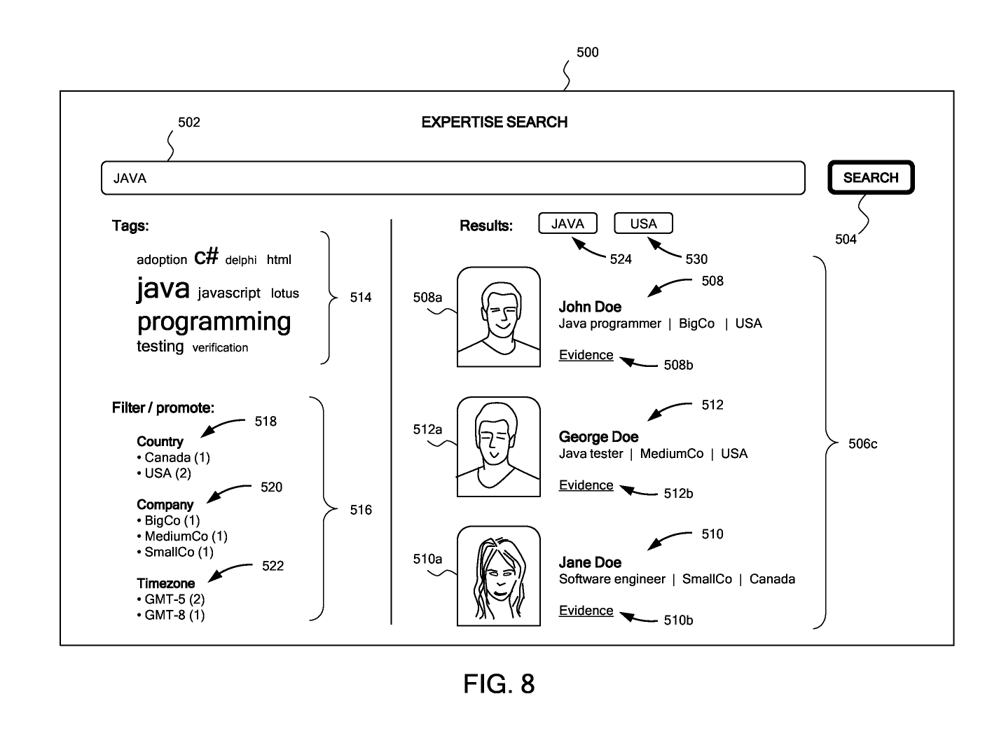

FIG. 8, to which reference is now made, shows GUI 500 after the user selected the company facet 520 value “USA”, and indicated that a promotion (or “boosting”) based on that value is desired. Differently from FIG. 7, which shows a filtering functionality, FIG. 8 shows a scenario in which results are not removed from the displayed set, but are rather arranged in accordance with the user's desire for promotion of certain personal profiles. As shown, John Doe 508 and George Doe 512, which are both from the USA, appear at the top of a rearranged set 506c, and Jane Doe 510, which is from Canada and not from the USA, remains in the rearranged list but in a demoted position. Since all of profiles 508-512 remain in rearranged set 506c, all facets also remain in tag cloud 514 and section 516.

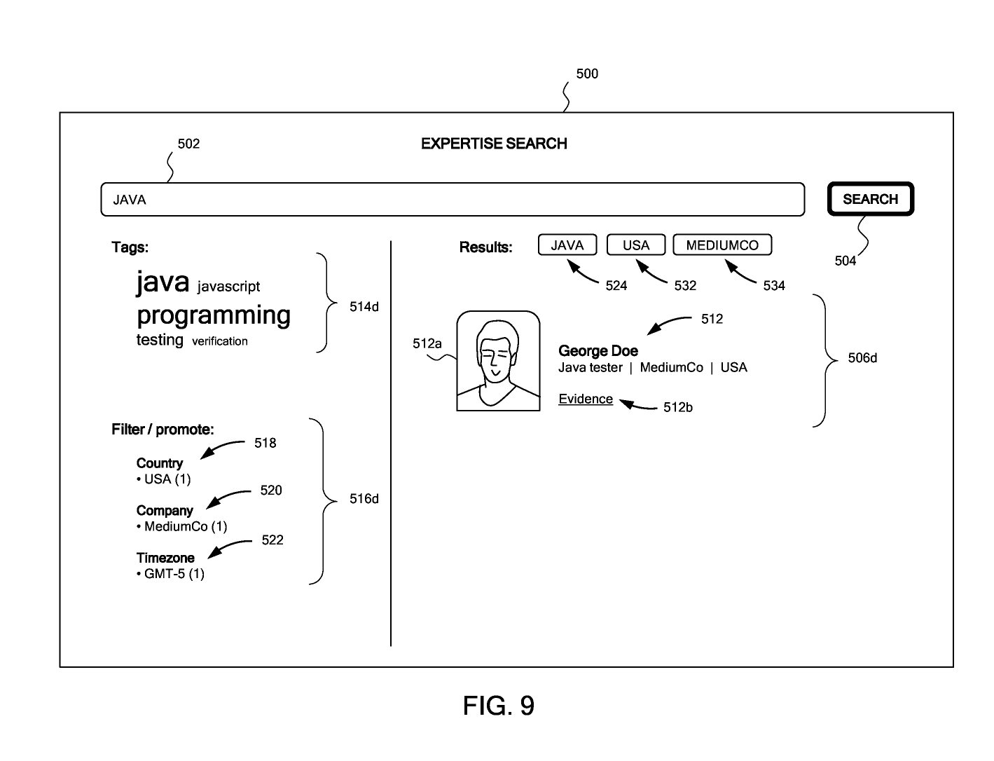

Each of FIGS. 6, 7 and 8 demonstrated a scenario where a single user action has been acted upon. Reference is now made to FIG. 9, which shows GUI 500 in a scenario where a drill-down of two levels is made. For the sake of brevity, no figures are shown for a drill-down of more than two levels, but those of skill in the art will recognize that such deeper drill-down may be facilitated based on the present discussions.

In the drill-down of FIG. 9, the user has selected to filter set 506 (FIG. 5) in accordance with a USA facet value and a MediumCo facet value, resulting in a filtered set 506d. Corresponding breadcrumbs, namely—USA breadcrumb 532 and MediumCo 524 breadcrumb may be added. This twofold user selection may be performed simultaneously or incrementally. In the simultaneous option, the user may select, for example, checkboxes (not shown) next to the USA facet value and the MediumCo facet value. Then, the user may issue an execution command, thereby causing a twofold filtering—by USA and MediumCo—to occur. In the incremental option, the user may first filter set 506 (FIG. 5) by one facet value, and, after the set has been filtered, execute a second filtering by a second facet value.

Since only George Doe 512 is included in filtered set 506d, tag cloud 514 (FIG. 5) has been filtered to a filtered tag could 514d. Similarly, section 516 (FIG. 5) has been filtered to a filtered section 516d.

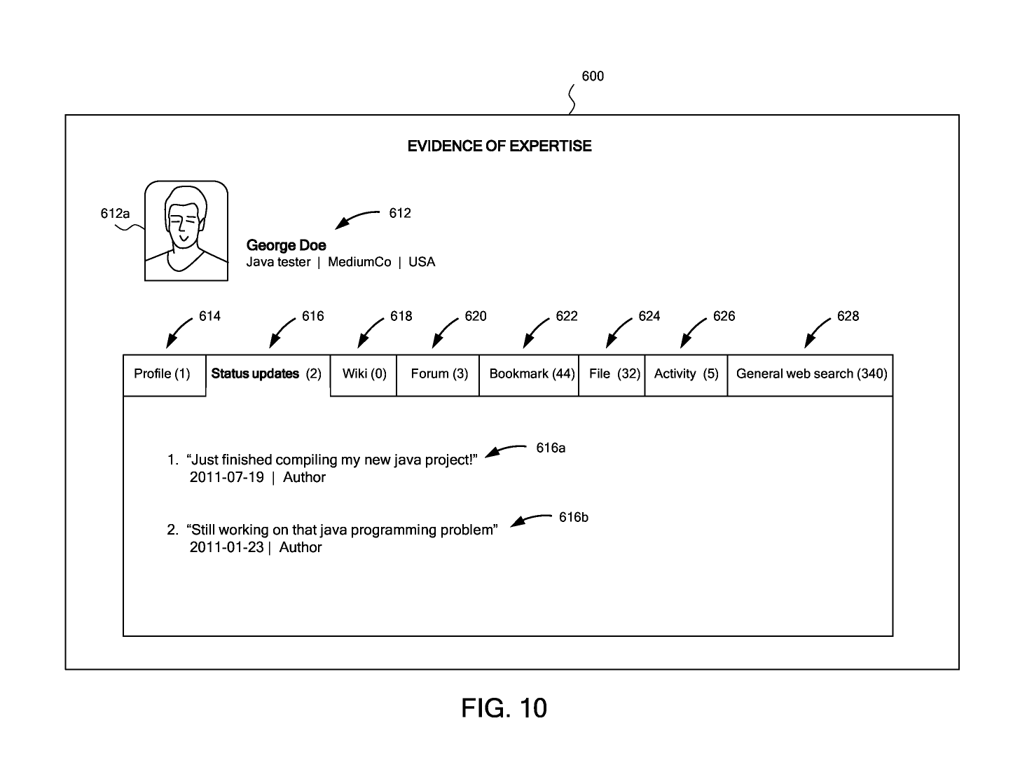

Reference is now made to FIG. 10. An additional GUI 600 may be provided, in accordance with present embodiments, for displaying evidence for the set of personal profile results 506 (FIG. 5). The term “evidence”, as referred to herein, may relate to documents based on which it was deduced, for example by method 400 (FIG. 4), that a certain person has a certain expertise. In the exemplary FIG. 10, evidence of the expertise of George Doe 612 in Java is demonstrated.

The name of George Doe 612 and optionally his photograph 612a may be displayed in GUI 600, for example at a top part of the GUI.

The evidence may be displayed in any suitable format. As one example, the evidence may be arranged by type, for instance using tabs. The following exemplary tabs are shown: profile 614, status updates 616, wiki 618, forum 620, bookmark 622, file 624, activity 626 and general web search 628. However, those of skill in art will recognize that evidence (namely—documents) may be classified in accordance with many different classifications.

For purposes of illustration only, status updates tab 616 is shown active, and two exemplary status updates are displayed in it. A first status update 616a reads “Just finished compiling my new java project!”. This first status update 616a is dated Jul. 19, 2011, and George Doe 612 is associated with this first status update (namely—with this document) by being its author.

A second status update 616b reads “Still working on that java programming problem”. This second status update 616b is dated Jan. 23, 2011, and George Doe 612 is associated with this second status update (namely—with this document) by being its author.

Optionally, one or more of tags 614-628 may include a document count (or “enumeration”) at their heading, for example in parentheses. For instance, profile tag 614 is shown with a count of 1, indicating that a single document of “profile” type is available. As another example, file tab 624 is shown with a count of 32, indicating that 32 documents of “file” type are available.

The flowcharts and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method comprising using at least one hardware processor for:
executing, based on a query, a document-oriented search in an index of documents each associated with at least one profile, to output a set of document results;
executing, based on the set of document results, a profile-oriented search in an index of profiles, to output a set of profile results and facets associated with the profile results; and
displaying the set of profile results and the facets.

2. The method according to claim 1, wherein said executing of the profile-oriented search comprises enumerating the facets of the set of profile results and displaying a result of said enumerating.

3. The method according to claim 2, further comprising using said at least one hardware processor for filtering the set of profile results based on a user request to drill-down into one or more of said facets of the set of profile results.

4. The method according to claim 2, further comprising using said at least one hardware processor for ranking the set of profile results based on a user request to promote profiles of the set of profile results having a defined facet value.

5. The method according to claim 1, wherein said index of profiles is an index of personal profiles.

6. The method according to claim 5, wherein said query is descriptive of an expertise.

7. The method according to claim 1, further comprising using said at least one hardware processor for ranking the set of profile results according to relevancy.

8. A computer program product for conducting a database search, the computer program product comprising a non-transitory computer-readable storage medium having program code embodied therewith, the program code executable by at least one hardware processor to:
execute, based on a query, a document-oriented search in an index of documents each associated with at least one profile, to output a set of document results;
execute, based on the set of document results, a profile-oriented search in an index of profiles, to output a set of profile results and facets associated with the profile results; and
display the set of profile results and the facets.

9. The computer program product according to claim 8, wherein said execute of the profile-oriented search comprises enumerating the facets of the set of profile results and displaying a result of said enumerating.

10. The computer program product according to claim 9, wherein the program code is further executable by said at least one hardware processor to filter the set of profile results based on a user request to drill-down into one or more of said facets of the set of profile results.

11. The computer program product according to claim 8, wherein said index of profiles is an index of personal profiles.

12. The computer program product according to claim 11, wherein said query is descriptive of an expertise.

13. The computer program product according to claim 8, wherein the program code is further executable by said at least one hardware processor to rank the set of document results according to relevancy.

14. The computer program product according to claim 8, wherein the program code is further executable by said at least one hardware processor to rank the set of profile results according to relevancy.

15. A method comprising using at least one hardware processor for:
receiving a query;
searching a document index with the query, to return a set of document results, wherein each document in the document index is associated with at least one personal profile;
searching a personal profile index for the at least one personal profile, to return a set of personal profile results and facets associated with the personal profile results; and
displaying the set of personal profile results and the facets.

16. The method according to claim 15, further comprising using said at least one hardware processor for ranking said set of personal profile results in accordance with an intensity of association between:
the query;
each document of the set of document results; and
each personal profile of the set of personal profile results.

17. The method according to claim 15, wherein said searching of the personal profile index comprises enumerating the facets of the set of personal profile results and displaying a result of said enumerating.

18. The method according to claim 17, further comprising using said at least one hardware processor for filtering the set of personal profile results based on a user request to drill-down into one or more of said facets of the set of personal profile results.

19. The method according to claim 15, wherein said query is descriptive of an expertise.

20. The method according to claim 15, wherein said searching of the document index and said searching of the personal profile index are performed automatically, based on said receiving of the query.
